(19) United States
(12) Patent Application Publication
(10) Pub. No.: US 2016/0372729 A1
(43) Pub. Date: Dec. 22, 2016

(54) Laminated Composite Separator, Method and Application

(71) Applicant: CORNELL UNIVERSITY, Ithaca, NY (US)

(72) Inventors: Lynden A. Archer, Ithaca, NY (US); Zhengyuan Tu, Jiangxi (CN)

(73) Assignee: CORNELL UNIVERSITY, Ithaca, NY (US)

(21) Appl. No.: 14/900,298

(22) PCT Filed: Jul. 3, 2014
(86) PCT No.: PCT/US2014/045384

§ 371 Date: Dec. 21, 2015

Related U.S. Application Data
(60) Provisional application No. 61/969,433, filed on Mar. 24, 2014.
(60) Provisional application No. 61/842,679, filed on Jul. 3, 2013.

(51) Int. Cl. H01M 2/16; H01M 10/0525; H01M 2/14

(52) U.S. Cl. CPC H01M 2/1686; H01M 2/1646; H01M 2/145; H01M 2/1653; H01M 10/0525

(57) ABSTRACT

A sandwich-type laminated composite for a battery separator that may be infused with a battery electrolyte uses a corer layer comprising a first nanoporous material to which is laminated upon opposite sides a pair of cladding layers comprising a second nanoporous materials different from the first nanoporous material and comprising a polymer material. A particular construction uses a nanoporous alumina core material and a pair of PVDF-FEP cladding layers to provide the sandwich-type laminated composite.

### CROSS-REFERENCE TO RELATED APPLICATION

This application is related to, and derives priority from, U.S. Provisional Patent Application Ser. No. 61/842,679 filed 3 Jul. 2013 entitled Laminated Composite Separator, Method and Application and 61/969,433 filed Mar. 24, 2014 entitled Stable Metal Battery, Method and Applications, the subject matters of which are incorporated herein fully by reference.

### STATEMENT OF GOVERNMENT INTEREST

The research that lead to the embodiments as described herein, and the invention as claimed herein, was supported by: (1) the United States Department of Energy, Office of Science, Office of Basic Energy Sciences, under award number DESC0001086; and (2) the United States National Science Foundation, under grant number DMR 1120296. The United States Government may have rights in the invention as claimed herein.

### BACKGROUND OF THE INVENTION

Field of the Invention

Embodiments relate generally to battery components, such as but not limited to lithium ion battery components. More particularly, embodiments relate to battery components, such as but not limited to lithium ion battery components, with enhanced performance.

Description of the Related Art

Advances in materials that enable safe and high density electrochemical energy storage are understood to be a critical element for advances in portable electronic devices and electric vehicle transportation. Progress in both of these fields requires safe, high density and reliable electrochemical energy storage. Due to their theoretically high energy density, low internal resistance and minimal memory effects, lithium ion batteries (LIBs) currently provide an attractive electrochemical energy storage option.

While LIBs are thus desirable within the context of electrochemical energy storage, LIBs are nonetheless not entirely without problems within the context of electrochemical energy storage. To that end LIBs suffer from compromised non-optimal energy storage density, and also from safety deficiencies.

Thus desirable are additional methods and materials that provide LIBs with enhanced optimal energy storage density and safe operation.

### SUMMARY

Embodiments provide a nanoporous separator for use within a battery, such as but not limited to a LIB. In accordance with the embodiments, the nanoporous separator exhibits both a high mechanical modulus at room temperature and (in conjunction with an appropriate electrolyte) a facile ion transport at room temperature. In general, the nanoporous separator in accordance with the embodiments is fabricated by forming laminated to opposite sides of a nanoporous metal oxide core membrane that has a high pore density a pair of macroporous (i.e., also nanoporous, and having a substantial number of pores greater than about 500 nanometers) thermoplastic polymer cladding layers, to fabricate a sandwich-type laminated nanoporous separator for use within the battery, such as but not limited to the LIB.

A specific example of an embodied nanoporous separator is fabricated by laminating to each side of a nanoporous γ-Al₂O₃ membrane core which has a high pore density a macroporous poly(vinylidene-fluoride-co-hexafluoropropene) (PVDF-HFP) polymer cladding layer to provide the sandwich-type laminated nanoporous separator which is illustrated more particularly in FIG. 1.

The resulting sandwich-type laminated nanoporous separator in accordance with the embodiments particularly exhibits improved toughness, in comparison with a nanoporous metal oxide membrane alone, such as but not limited to a nanoporous γ-Al₂O₃ membrane alone, and readily infuses an electrolyte based on 1M lithium bis(trifluoromethanesulfone) imide (LiTFSI) in propylene carbonate (PC) to produce an electrolyte infused sandwich-type laminated nanoporous separator with an ionic conductivity at least about 1 mS/cm at room temperature and a mechanical modulus of at least about 0.5 GPa at room temperature (i.e., about 25 degrees centigrade). It is believed that this is the first electrolyte infused nanoporous separator to exhibit the foregoing attractive combination of mechanical properties and ion transport properties at room temperature.

The embodiments are understood within the context of the sandwich-type laminated nanoporous composite described above, the sandwich-type laminated nanoporous separator as described above, a battery that includes the sandwich-type laminated nanoporous separator as described above and a method for fabricating the sandwich-type laminated nanoporous separator as described above.

A particular composite in accordance with the embodiments includes a core membrane comprising a first nanoporous material. This particular composite also includes a pair of cladding material layers one laminated to each side of the core membrane. The pair of cladding material layers comprises a second nanoporous material different from the first nanoporous material, and also comprises a polymer material.

A particular battery separator in accordance with the embodiments includes a core membrane comprising a first nanoporous material. This particular battery separator also includes a pair of cladding material layers one laminated to each side of the core membrane, the pair of cladding material layers comprises a second nanoporous material different from the first nanoporous material, and also comprises a polymer material. This particular battery separator also includes a battery electrolyte infused into the core membrane and the pair of cladding material layers.

A particular battery in accordance with the embodiments includes an anode separated from a cathode by a separator comprising: (1) a core membrane comprising a first nanoporous material; (2) a pair of cladding material layers one laminated to each side of the core membrane, the pair of cladding material layers comprising a second nanoporous material different from the first nanoporous material, and also comprising a polymer material; and (3) a battery electrolyte infused into the core membrane and the pair of cladding material layers.

A particular method for fabricating a composite in accordance with the embodiments includes anodically oxidizing a metal conductor material membrane to provide a nanoporous metal oxide material membrane. This particular method also includes solution coating each side of the nanoporous metal oxide material membrane with a polymer material to provide a sandwich-type laminated nanoporous composite.

### BRIEF DESCRIPTION OF THE DRAWINGS

The objects, features and advantages of the embodiments are understood within the context of the Detailed Description of the Non-Limiting Embodiments, as set forth below. The Detailed Description of the Non-Limiting Embodiments is understood within the context of the accompanying drawings, that form a material part of this disclosure, wherein:

FIG. 1 at middle and at left shows a schematic cross-sectional view diagram and a schematic exploded view diagram of a PVDF-HFP/Al₂O₃ nanoporous separator in accordance with the embodiments. SEM images of the PVDF-HFP/Al₂O₃ nanoporous separator with 100 nm nanopores are shown in: (1) upper cross-section of the composite; (2) right cross-section of the internal alumina layer; and (3) bottom cross-section boundary between the internal alumina layer and the cladding polymer layer.

FIG. 2 shows a typical atomic force microscopy (AFM) spectrum from an AFM measurement apparatus that may be used to measure the modulus of a brittle nanoporous alumina membrane component within a PVDF-HFP/Al₂O₃ nanoporous separator in accordance with the embodiments.

FIG. 3 shows scanning electron microscopy (SEM) images of a pristine nanoporous alumina membrane with 200 nm pores for use within a PVDF-HFP/Al₂O₃ nanoporous separator in accordance with the embodiments.

FIG. 4 shows AFM images of a pristine nanoporous alumina membrane generally in accord with FIG. 3, but with 20 nm pores.

FIG. 5 shows: (a) storage modulus of a PVDF-HFP/Al₂O₃ nanoporous separator with various pore sizes, in comparison with pure PVDF-HFP cladding material as a function of temperature; (b) DC ionic conductivity of a PVDF-HFP/Al₂O₃ nanoporous separator with various pore sizes after immersing in LiTFSI/PC, and a nanoporous separator with 100 nm pores in LiTFSI/PEG; (c) impedance spectra of PVDF-HFP/100 nm Al₂O₃/LiTFSI/PC electrolyte saturated nanoporous separator versus temperature; and (d) bulk resistance and interfacial resistance of the composition in (c) versus temperature, analyzed using the equivalent circuit as inset.

FIG. 6 shows a graph of storage modulus versus temperature of a PVDF-HFP/Al₂O₃/LiTFSI/PC electrolyte saturated nanoporous separator. Due to safety concerns, the measurement is obtained at only a small range of temperature.

FIG. 7 shows DC ionic conductivity of a PVDF-HFP/Al₂O₃ nanoporous separator with various pore sizes after immersing in LiTFSI/PC, and another nanoporous separator with 100 nm pores in LiTFSI/PEG. The solid lines are Arrhenius curve fittings to the experimental data.

FIG. 8 shows a typical plot of conductivity data versus frequency at various temperatures for a PVDF-HFP/Al₂O₃/LiTFSI/PC electrolyte saturated separator.

FIG. 9 shows: (1) an impedance spectra for a PVDF-HFP/Al₂O₃/LiTFSI/PC electrolyte saturated nanoporous separator at (a) 20 nm; and (b) 200 nm, versus temperature; and (2) bulk resistance and interfacial resistance of the nanoporous separators at (c) 20 nm; and (d) 200 nm, versus temperature, analyzed using the equivalent circuit as inset.

FIG. 10 shows galvanostatic charging/discharging plots for LTO/composite electrolyte saturated nanoporous (100 nm)/Li fuel cell under: (a) 0.315 mA cm⁻² (1C) and (b) 1.575 mA cm⁻² (5C). Discharge and charge voltage profiles versus capacity for 1^{st}, 100^{th}, and 1000^{th} cycle for (c) 0.315 mA cm⁻² (1C) and (d) 1.575 mA cm⁻² (5C).

FIG. 11 shows a thermo-gravimetric analysis TGA profile for 100 nm Al₂O₃/1M LiTFSI/PC electrolyte saturated nanoporous separator and 100 nm Al₂O₃/1M LiTFSI/PEG electrolyte saturated nanoporous separator from room temperature up to 550C. The mass drop is mainly due to the lower temperature decomposition of PC and the higher temperature decomposition of polymer.

FIG. 12 shows (a) galvanostatic charging/discharging plots for LTO/electrolyte saturated nanoporous separator (100 nm)/Li full cell under 0.630 mA cm² (2C); and (b) voltage as a function of capacity for 1^{st}, 100^{th}, and 1000^{th} cycle for (a).

FIG. 13 shows a voltage profile for a lithium plating/striping experiment as a function of time for a symmetric lithium coin cell cycled at a fixed current density of 0.02 mA cm⁻² using: (a) PVDF-HFP/100 nm Al₂O₃/PC-LiTFSI electrolyte saturated nanoporous separator; and (b) PVDF/LiTFSI electrolyte saturated nanoporous separator.

FIG. 14 shows voltage profiles for a lithium plating/striping experiment as a function of time for a symmetric lithium coin cell with PVDF-HFP/100 nm Al₂O₃/LiTFSI/PC electrolyte saturated nanoporous separator (a) 0.02 mA cm⁻²; (b) 0.05 mA cm²; (c) 0.1 mA cm⁻²; and (d) 0.2 mA cm⁻²

FIG. 15 shows (a), (b) SEM images of a center of a nanoporous separator after the foregoing lithium plating/striping experiment. A lithium dendrite covers a surface of the nanoporous separator while not penetrating the separator. (c), (d) SEM images of the edge of the nanoporous separator, showing that some dendrite might grow passing the edge of the separator.

FIG. 16 shows an XRD curve of PVDF-HFP/100 nm Al₂O₃/LiTFSI/PC electrolyte saturated nanoporous separator after lithium plating/striping experiment and pristine 100 nm alumina. However, due to the noise caused by the amorphous cladding polymer and alumina, no recognizable signals can be discerned.

### DETAILED DESCRIPTION OF THE NON-LIMITING EMBODIMENTS

Embodiments include a particular sandwich-type laminated nanoporous separator for use within a battery, such as but not limited to a LIB. The sandwich-type laminated nanoporous separator provides when infused with a suitable electrolyte has both a high mechanical modulus at room temperature and a facile ion transport at room temperature.

### General Embodiments

In concert with the suggestion above that a nanoporous separator in accordance with the embodiments may be used within a battery such as but not limited to a LIB, the embodiments in general contemplate use of a nanoporous separator within a metal based battery that uses a metal based electrode (i.e., metal electrode or metal ion electrode) selected from the group including but not limited to lithium, sodium, potassium, aluminum, zinc, copper and lead metal based electrodes.

Similarly, although the embodiments illustrate in particular a γ-Al₂O₃ membrane core with a high pore density located laminated between a pair of macroporous poly(vinylidene-fluoride-co-hexafluoropropene) (PVDF-HFP) polymer cladding layers to provide a sandwich-type laminated nanoporous separator in accordance with the embodiments, the embodiments again are not intended to be so limited. Rather in place of a γ-Al₂O₃ membrane as a core within a nanoporous separator in accordance with the embodiments, the embodiments also contemplate membranes formed from other nanoporous metal oxide materials including but not limited to titanium oxide, silicon oxide, vanadium oxide, tin oxide and zirconium oxide metal oxide materials, as well as glass materials and carbon materials.

Moreover, the embodiments also contemplate alternative cladding polymer material layers in place of the macroporous poly(vinylidene-fluoride-co-hexafluoropropene) (PVDF-HFP) cladding polymer material layers, wherein such cladding polymer material layers may include cladding polymer materials including but not necessarily limited to non-fluorinated polyolefin polymer materials and fluoroionomer polymer materials such as but not limited to Nafion fluoroionomer polymer materials.

In addition, the embodiments also contemplate a broader range of electrolyte materials than are specifically illustrated. For example, the embodiments are generally predicated upon PC/LiTFSI as an electrolyte when in reality the electrolyte could alternatively be PC/[(1−y)LiTFSI+yLiF] where y varies from 0 to 1

Furthermore, any liquid with a high dielectric constant that is compatible with metallic lithium (e.g. (DMSO (dimethyl sulfoxide), PC (propylene carbonate), EC (ethylene carbonate), DEC (diethylene carbonate), DMC (dimethyl carbonate), TEGDME (tetraethylene glycol dimethyl ether), or MPEG (methoxy terminated polyethylene glycol) with molecular weight<2000) to name a few, could be used in the electrolyte.

Within the context of the embodiments, a nanoporous metal oxide membrane core for a nanoporous separator in accordance with the embodiments may have a nanopore size from about 2 to about 500 nanometers and more preferably from about 10 to about 200 nanometers. Typically, such a nanoporous metal oxide membrane has a pore density greater than about 50 area percent. Typically such a nanoporous metal oxide membrane core has a thickness from about 1 to about 100 microns.

Within the context of the embodiments, a macroporous cladding polymer material layer has a thickness from about 2 nanometers to about 20 microns and a nanopore size from about 2 to about 500 nanometers as above, and also an area pore density greater than about 50 area percent.

### Specific Embodiment

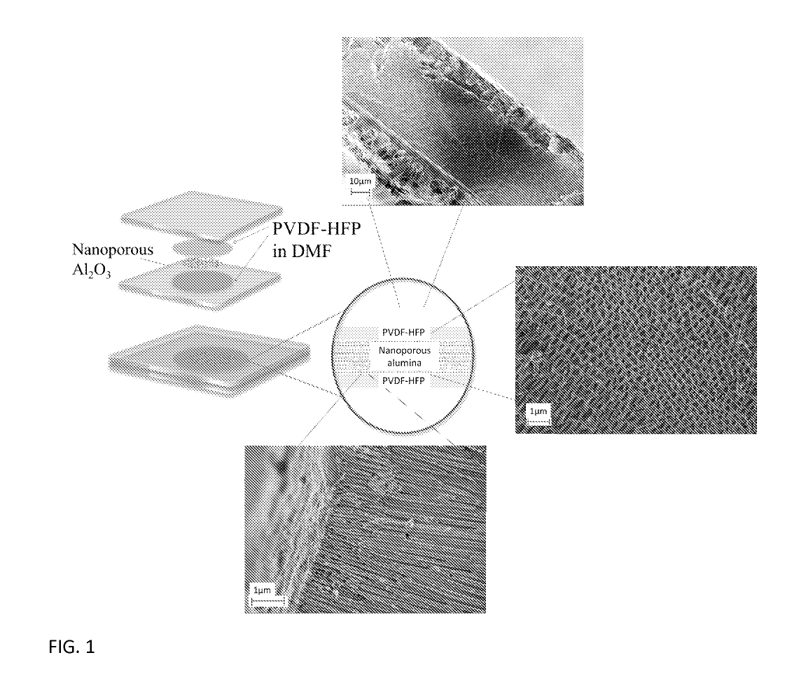

Desirably, a sandwich-type laminated nanoporous separator is fabricated by laminating a nanoporous γ-Al₂O₃ membrane core with a high pore density between a pair of macroporous poly(vinylidene-fluoride-co-hexafluoropropene) (PVDF-HFP) polymer layers to create a sandwich-type laminated nanoporous separator as illustrated particularly in FIG. 1.

The resulting nanoporous separator exhibits desirably improved toughness, in comparison with a nanoporous γ-Al₂O₃ membrane core alone, and readily infuses an electrolyte based on 1M lithium bis(trifluoromethanesulfone) imide (LiTFSI) in propylene carbonate (PC) to produce an electrolyte infused nanoporous separator comprising a material composition that provides an ionic conductivity greater than about 1 mS/cm and a mechanical modulus greater than about 0.5 GPa, each at room temperature of nominally 25 degrees centigrade. It is believed that a materials combination in accordance with the embodiments is the first materials combination to exhibit this attractive combination of mechanical properties and ion transport properties at room temperature for use within a battery separator.

Within the context of this more specific embodiment, a nanoporous γ-Al₂O₃ membrane core may be prepared by voltage-controlled anodic oxidation of metallic aluminum, and it is possible to precisely manipulate the pore dimensions through a processing voltage. Typically such an oxidation method uses an aluminum electrode on copper or nickel, versus an aluminum metal electrode, in an acid solution.

PVDF-HFP/γ-Al₂O₃ nanoporous separators were prepared from a nanoporous γ-Al₂O₃ membrane core using a phase separation method described in the Experimental Section that is provided below. The resultant nanoporous separator composite films were immersed in a 1M LiTFSI/PC solution to form the electrolyte infused nanoporous separators used for electrochemical studies.

A scanning electron microscope image as illustrated in FIG. 1 shows that a nanoporous separator in accordance with the embodiments possesses a tri-layer laminated structure, in which the top and the bottom layers are PVDF-HFP and the middle layer is alumina comprised of a dense, uniform distribution of nanometer-sized pores. Before laminating with the PVDF-HFP, the porous alumina membrane core is extremely brittle which makes it difficult to handle. The macroporous PVDF-HFP coating produced by a phase separation procedure provides exceptionally high levels of mechanical reinforcement for the alumina membrane core, without infiltrating the pores. This configuration results in a sandwich-type laminated nanoporous separator with dramatically higher mechanical flexibility, high mechanical modulus, and room temperature conductivity approaching that of the liquid PC/LiTFSI electrolyte hosted in the open pores of a PVDF-HFP/Al₂O₃ laminate.

A shear mechanical modulus may be theoretically and intuitively considered an important physical property for assessing the ability of an electrolyte infused nanoporous separator to impede lithium dendrite growth in a LMB. Because of its brittleness, the mechanical modulus of the unlaminated nanoporous Al₂O₃ membrane core cannot be characterized using normal mechanical testing methods.

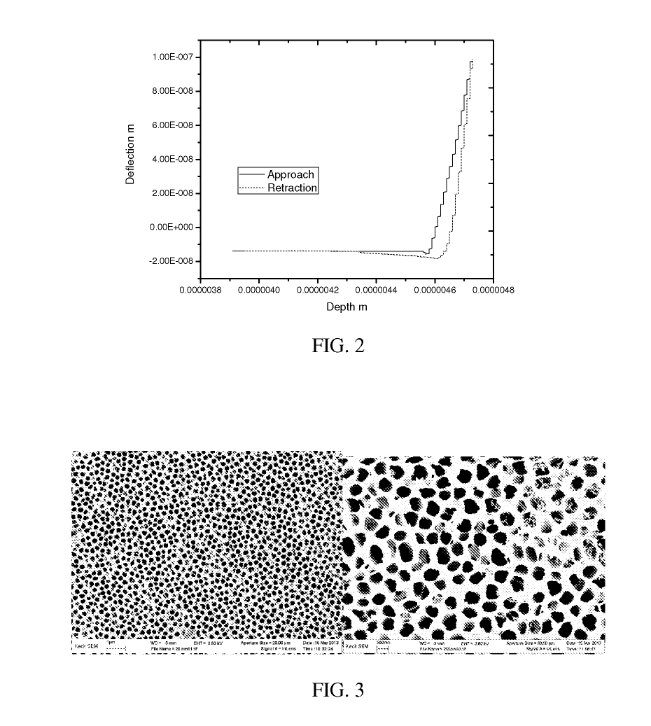

One may instead employ an atomic force microscopy (AFM) analysis to first obtain a load-displacement curve as is illustrated generally in FIG. 2, and by applying a theoretical approximation method in accordance with Oliver and Pharr that allows a modulus to be obtained in a penetration mode subsequently deduce a reduced elastic modulus of the Al₂O₃ membrane core to be around 500 MPa. This value is substantially lower than the theoretical modulus for bulk Al₂O₃ and somewhat lower than expected even if one factors in the nanoporous nature of the material. The foregoing elastic modulus value suggests that even the very small strains applied in the AFM measurement may cause some amount of brittle failure of an unlaminated Al₂O₃ membrane core sheet material.

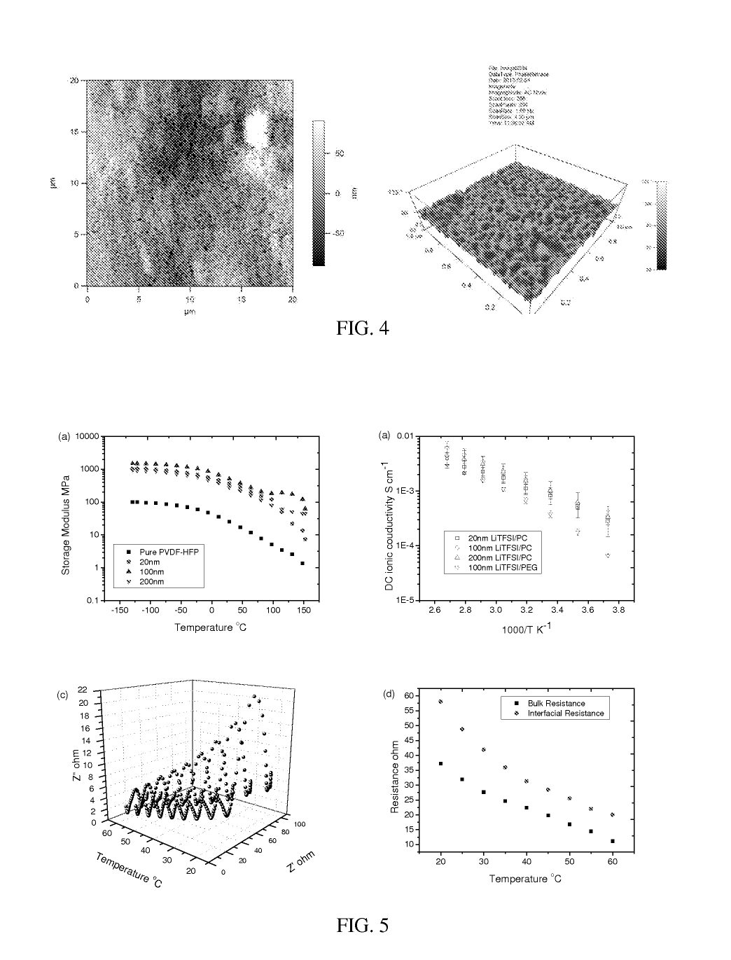

For reference purposes, an SEM image of a nanoporous Al₂O₃ membrane core is shown in FIG. 3 and a related AFM image is shown in FIG. 4.

Mechanical properties are considerably improved for the PVDF-HFP/Al₂O₃ nanoporous separator in accordance with the embodiments, which can be subjected to orders of magnitude larger mechanical deformations without showing any evidence of mechanical failure. FIG. 5a shows the elastic/storage modulus of PVDF-HFP/Al₂O₃ nanoporous separator measured using dynamic mechanical analysis of a bulk specimen over a broad range of temperature (−130° C. to 150° C.). The pore size of the Al₂O₃ nanoporous core sheet is varied from 20 nm to 200 nm. FIG. 5a also presents data for the macroporous PVDF-HFP copolymer film without the Al₂O₃ nanoporous membrane core, for comparison. It is apparent that irrespective of the measurement temperature, the elastic modulus for the PVDF-HFP/Al₂O₃ nanoporous separator is about one order of magnitude higher than that of the PVDF-HFP cladding polymer alone and exhibits at most a weak dependence on the nanopore dimensions. At room temperature the elastic modulus is close to 0.4 GPa for the nanoporous separator with the largest Al₂O₃ pore dimension. In every case, the elastic modulus decreases gradually with increasing temperature, which is attributed to the broad glass transition region of the highly random PVDF-HFP copolymer.

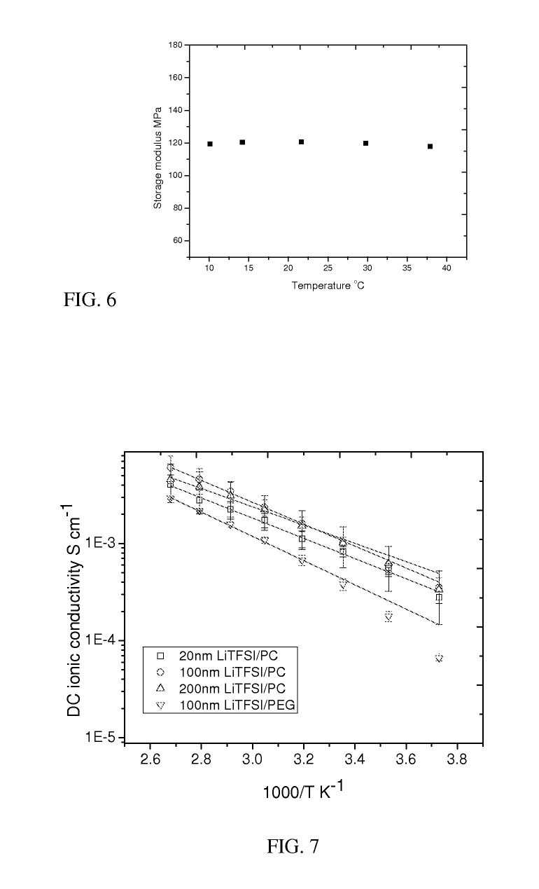

After infusing the PVDF-HFP/Al₂O₃ nanoporous separator in a 1M LiTFSI/PC electrolyte one obtains an electrolyte infused nanoporous separator that becomes even tougher, but also more slippery, which makes it difficult to measure a mechanical modulus of an electrolyte infused nanoporous separator. Based on several repeat experiments one may conclude that a storage modulus of a nanoporous separator in accordance with the embodiments based on Al₂O₃ is at least 0.15 GPa, as illustrated in FIG. 6.

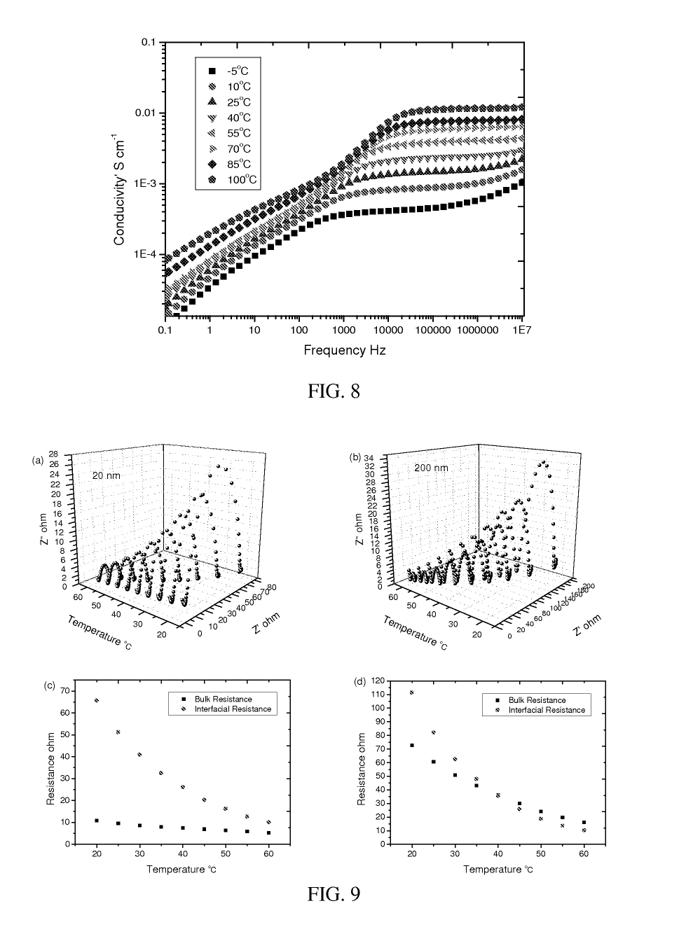

FIG. 5b shows the conductivity of PVDF-HFP/Al₂O₃/LiTFSI/PC electrolyte infused nanoporous separator with different pore sizes for temperatures ranging from −5° C. to 100° C. The DC conductivity is determined from AC measurements as illustrated in FIG. 8 by a method proposed by Jonscher. The conductivity of PVDF-HFP/Al₂O₃/LiTFSI/PC electrolytes with 100 nm and 200 nm pore sizes are over 1×10⁻³ S cm⁻¹ at room temperature, which is close to that of the LiTFSI/PC liquid electrolyte. Such high conductivity is attributed to the unrestricted movement of LiTFSI in liquid PC hosted in the pores of the nanoporous separator in accordance with the embodiments. The electrolyte infused nanoporous separator based on Al₂O₃ with 20 nm pores in accordance with the embodiments shows slightly lower conductivity (8×10⁻⁴ S cm⁻¹) at room temperature, which may be evidence that the decreased pore size to some extent hinders the ion transport. The solid lines through the data are fitted using the Arrhenius equation as illustrated in FIG. 7, where σ=A exp(−Eₐ/RT). The deviations between theory and data in the low temperature region is attributed to the broad glass transition temperature of PVDF-HFP. The activation energy obtained from related data analysis is provided in Table 1 as follows. The activation energy value results are evidently all close to consensus values for PC-LiTFSI, implying that the pore dimensions are large enough that the PVDF-HFP/Al₂O₃ serves essentially as a host for the liquid PC-LiTFSI electrolyte.

TABLE 1

| | Conductivity at | Activation Energy |
|---|---|---|
| Sample description # | 25 C. [S cm⁻¹] | Ea[eV] |
| LiTFSI/PC/20 nm alumina | 8.30E−4 | 0.20674 ± 0.00968 |
| LiTFSI/PC/100 nm alumina | 1.01E−3 | 0.22375 ± 0.00684 |
| LiTFSI/PC/200 nm alumina | 1.07E−3 | 0.18680 ± 0.00712 |
| LiTFSI/PEG/100 nm alumina | 3.80E−4 | 0.24762 ± 0.01585 |

In addition to facilitating good ion transport in bulk, a suitable electrolyte for a LMB must also present low barriers for injection and removal of Li ions at the electrode/electrolyte interface. FIG. 5c reports impedance spectra of a PVDF-HFP/Al₂O₃/LiTFSI/PC material based on Al₂O₃ with 100 nm nanopores measured in a symmetric lithium coin cell as a function of temperature. By fitting the results to the equivalent circuit model depicted in the inset to FIG. 5d both the bulk and interfacial resistance can be obtained as illustrated in Table 2. It is apparent that both the interfacial and bulk resistances at 25° C. are low (48.8Ω and 31.9Ω, respectively) and as expected decrease with increasing temperature. The corresponding room-temperature bulk and interfacial resistances for the electrolyte saturated nanoporous separators based on Al₂O₃ with 20 nm and 200 nm nanopores are, respectively, 9.5Ω, 51.2Ω, 60.6Ω and 82Ω (see FIG. 9 and Table 2). This is understood to indicate that for the range of pore dimensions studied, the materials are good candidates for application in batteries.

TABLE 2

| | Bulk | Interfacial | Bulk | Interfacial | Bulk | Interfacial |
|---|---|---|---|---|---|---|
| | Resistance | Resistance | Resistance | Resistance | Resistance | Resistance |
| Temperature C. | 20 nm (ohm) | | 100 nm (ohm) | | 200 nm (ohm) | |
| 20 | 10.77 ± 0.28 | 65.69 ± 1.85 | 37.20 ± 0.75 | 58.03 ± 1.46 | 72.78 ± 0.83 | 111.40 ± 1.34 |
| 25 | 9.49 ± 0.24 | 51.20 ± 1.38 | 31.88 ± 0.69 | 48.78 ± 1.29 | 60.60 ± 0.66 | 82.00 ± 0.92 |
| 30 | 8.52 ± 0.20 | 40.94 ± 1.05 | 27.63 ± 0.57 | 41.86 ± 1.02 | 50.77 ± 0.49 | 62.40 ± 0.68 |
| 35 | 7.91 ± 0.18 | 32.52 ± 0.79 | 24.64 ± 0.50 | 35.93 ± 0.83 | 43.09 ± 0.40 | 47.90 ± 0.54 |
| 40 | 7.41 ± 0.15 | 26.01 ± 0.60 | 22.35 ± 0.45 | 31.32 ± 0.72 | 36.28 ± 0.39 | 35.70 ± 0.50 |
| 45 | 6.87 ± 0.13 | 20.18 ± 0.45 | 19.83 ± 0.50 | 28.43 ± 0.74 | 30.00 ± 0.39 | 25.93 ± 0.46 |
| 50 | 6.32 ± 0.12 | 16.14 ± 0.36 | 16.79 ± 1.82 | 25.52 ± 2.24 | 24.05 ± 0.21 | 18.75 ± 0.27 |
| 55 | 5.75 ± 0.11 | 12.65 ± 0.28 | 14.44 ± 0.92 | 21.99 ± 1.14 | 19.64 ± 0.18 | 13.69 ± 0.22 |
| 60 | 5.21 ± 0.10 | 10.00 ± 0.22 | 11.17 ± 1.41 | 20.04 ± 1.60 | 16.11 ± 0.16 | 10.29 ± 0.20 |

To assess the stability of the instant PVDF-HFP/Al₂O₃/LiTFSI/PC electrolyte saturated nanoporous separator in batteries employing metallic lithium anodes, one may perform electrochemical cycling of a Li/Li₄Ti₅O₁₂ cell utilizing a laminated material based on Al₂O₃ with 100 nm pores as both the separator and electrolyte. This cell configuration was chosen because of the well-known, stable electrochemical cycling of Li/Li₄Ti₅O₁₂ cells in conventional electrolytes at both low and high rates. It therefore allows the new separator and electrolyte materials to be evaluated at high current densities and over large numbers of charge-discharge cycles to establish their performance limits.

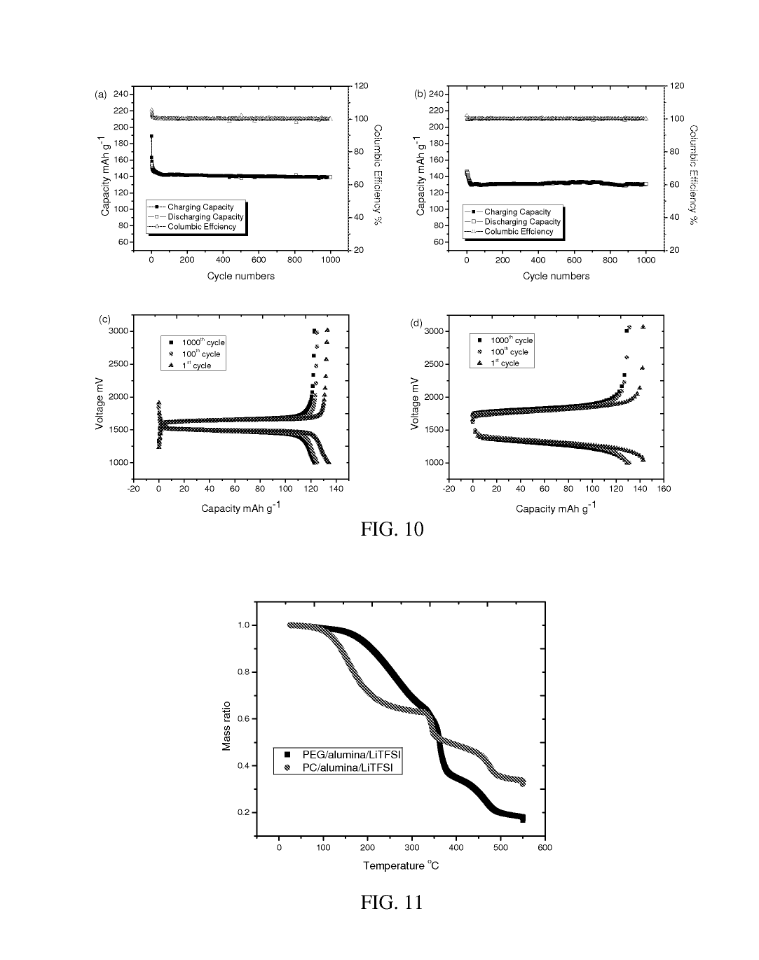

FIG. 10a and FIG. 10c illustrate the galvanostatic charge-discharge profiles after the 1st, 100th, and 1000th cycles at a fixed current density of 0.315 mA cm⁻² (1C) and 1.575 mA cm⁻² (5C). It is apparent that the voltage plateau, round-trip efficiency, and capacity retention are all quite high. FIG. 10b and FIG. 10d illustrate the capacity and Columbic efficiency as a function of cycle number. The experiment is also undertaken at 0.630 mA cm⁻² (2C), as illustrated in FIG. 12. It is apparent from FIG. 12 that apart from a small amount of capacity fading over the first few cycles, the cells exhibit stable, high-efficiency cycling over at least 1100 charge/discharge cycles, with no evidence of short circuiting and with a capacity approaching the theoretical maximum (175 mAh g⁻¹) for LTO.

To further evaluate the performance of the PVDF-HFP/Al₂O₃/LiTFSI-PC electrolyte in LMBs, one may employ a cyclic lithium plate/strip electrochemical procedure in a symmetric lithium cell to characterize performance over extended periods of time. Because the capacity of the cathode/anode is not limited by the finite capacity of the LTO host used for the experiments reported in FIG. 10, much larger amounts of lithium can be moved between electrodes within each cycle. In the present experiments, cells were periodically charged for 3 hours and discharged for 3 hours at a range of current densities. Formation of a short circuit in this configuration produces an internal path for current flow in the electrolyte, which causes the measured voltage to drop. Thus, by monitoring the voltage versus time during these strip/plate cyclic experiments, it is possible to identify the onset of short-circuiting from the voltage drop.

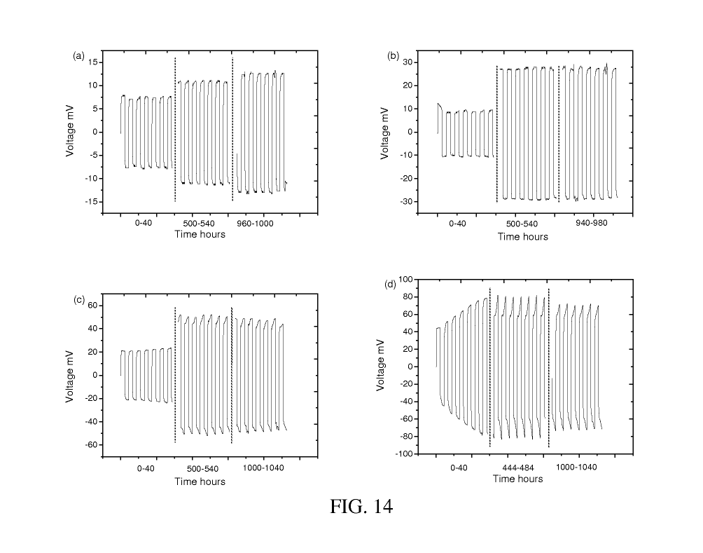

FIG. 13a depicts the time-dependent voltage profile for a cell based on the electrolyte saturated nanoporous separator containing Al₂O₃ with 100 nm pores, cycled for up to 1000 hours under a constant current density of 0.2 mA cm⁻². FIG. 13b report results from similar measurements, except without the nanoporous Al₂O₃ core sheet in the separator. It is seen that while cells based on the PVDF/Li-TFSI fail by short circuiting after as little as 60 hours of operation at 0.2mS cm⁻², cells based on the PVDF-HFP/Al₂O₃/PC-LiTFSI electrolyte exhibit stable voltage profiles even after 1000 hours of operation.

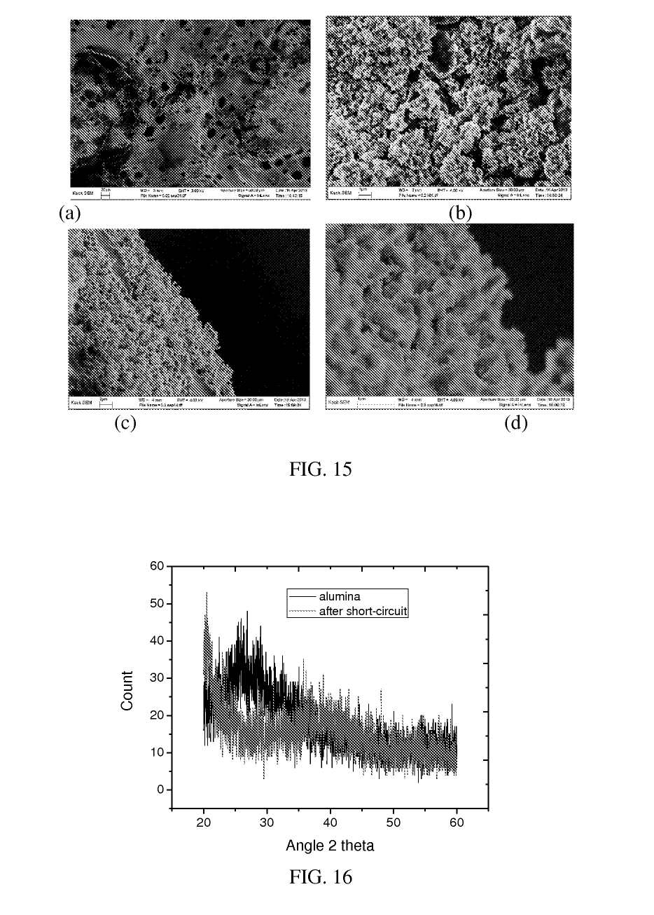

Results from similar measurements using PVDF-HFP/Al₂O₃/LiTFSI-PC electrolytes at both lower and higher current densities are provided in FIG. 14. It is apparent from these experiments that the materials are quite effective in stabilizing the cells against failure by short circuiting. Post mortem studies of the laminated separator (see FIG. 15 and FIG. 16) taken after 1000 hours of operation show that mossy deposits form in small patches on the surface and edges of the separator, but are apparently unable to penetrate it. As a comparison with earlier studies, the cell lifetimes achieved with the present PVDF-HFP/Al₂O₃/PC-LiTFSI materials are a substantial improvement over recent reports for a block copolymer electrolyte with storage modulus of 0.1 Gpa. Significantly, because the PVDF-HFP/Al₂O₃-based materials are more conductive, the present results are obtained from room temperature measurements, which represents an additional improvement over copolymer based electrolytes, which currently require battery operating temperatures of around 90° C.

In summary, described herein is an electrolyte saturated nanoporous separator comprised of laminated PVDF-HFP/Al₂O₃ sandwich-type laminated composite membranes infused with a conventional low-volatility liquid electrolyte. The materials are shown to be stable against metallic lithium and exhibit good toughness, high mechanical modulus, high ionic conductivity, and low interfacial impedances at room temperature. Using Li/LTO cells one may show that the materials allow for exceptional, stable cycling performances for more than 1000 charge/discharge cycles. In symmetric lithium/lithium cells, the PVDF-HFP/Al₂O₃ membranes exhibit more than 1000 hours of stable operation at current densities ranging from 0.02 to 0.2 mA cm⁻². These last results are substantial improvements over symmetric cells based on PVDF-HFP without the Al₂O₃ inter-layer, but soaked in the same liquid electrolyte; these cells fail in as little as 60 hours when cycled at 0.2 mA cm⁻².

Experimental

Polyvinylidene fluoride hexafluropropylene (PVDF-HFP, supplied by Sigma Aldrich.) was dissolved in N,N-dimethylformamide (DMF, supplied by Sigma Aldrich) at 10 wt % concentration. The viscous solution was poured onto a clean glass plate, covered by nanoporous alumina membrane (Whatman Anodise® 25 with 20 nm, 100 nm, 200 nm pore sizes, supplied by Fisher). The surface flatness and overall laminate membrane thickness were controlled using a doctor blade technique. The glass plate with materials on top was immersed in a water bath at room temperature. The formed solid composite separator was completely dehydrated in vacuum. To prepare the electrolyte infused nanoporous separator the nanoporous separator was soaked in 1M lithium bis(trifluoromethanesulfonyl)imide (LiTFSI)/propylene carbonate (PC) solution for at least 24 hours. The symmetric lithium coin cells and the full coin cells (both 2032 type) were prepared under argon protection (glove box, MBraun. Labmaster). The symmetric lithium coin cells have Li/nanoporous separator/Li structure, while the full coin cells have lithium titanate (LTO)/composite film/lithium structure. The LTO electrode is composed of 10% PVDF binder, 10% carbon black, and 80% LTO. A small amount of N-methylpyrrolidone (NMP) was used as solvent for homogenizing all components. The resultant slurry was coated on a copper plate and rigorously dried.

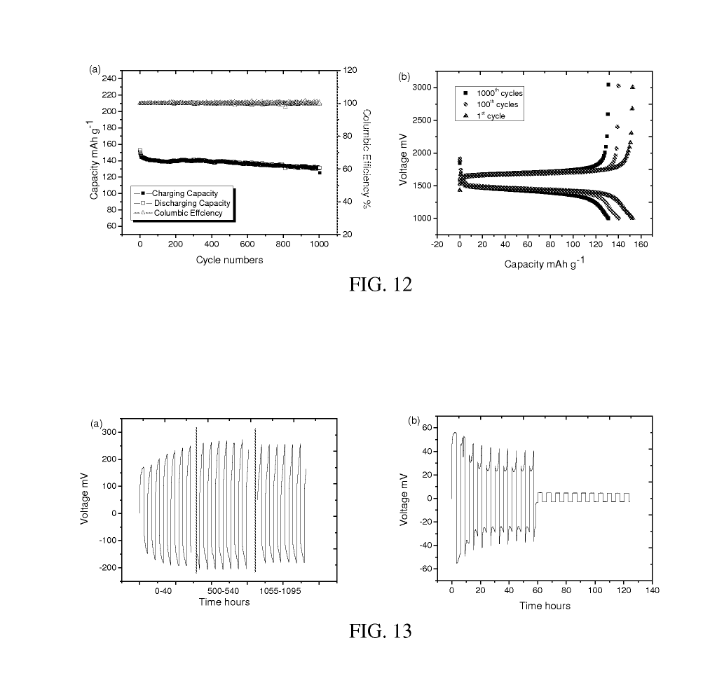

A thermogravimetric analysis (TGA) was used to study the thermal stability of PVDF-HFP/100 nm Al₂O₃/LiTFSI/PC and PVDF-HFP/100 nm Al₂O₃/LiTFSI/PEG electrolyte infused nanoporous separators, as illustrated in FIG. 11. Scanning electron microscopy (LEO-1550-FESEM) was used to characterize the laminated structure in the nanoporous separator. The nanoporous separator was cut in liquid nitrogen to achieve clean edges. The sample was placed vertically on a SEM stub for cross-section observation. The SEM images were obtained under 3 kV voltage with aperture size of 30 μm. Mechanical properties of the electrolyte infused nanoporous separator materials were characterized using dynamic mechanical analysis (DMA-Q800) in the temperature range from −130° C. to 150° C. A heating rate of 10° C. min⁻¹ and frequency of 1 Hz were employed fort these measurements. Atomic force microscopy (AFM, Asylum-MFP-3D-Bio-AFM) was used to indirectly measure the modulus of the unlaminated Al₂O₃ core sheet. The force mode was chosen to obtain the force plot against the indent depth. Conductivity and impedance were measured against frequency using a Novocontrol N40 broadband dielectric spectroscopy at different temperature from −5° C. to 100° C. The lithium plate/strip experiment and galvanostatic charge/discharge experiment were performed on a Neware CT-3008 battery tester. The plate-strip experiment was performed with symmetric lithium coin cells under different current density (0.02, 0.05, 0.1, and 0.2 mA cm⁻²). The coin cells harvested after the plate-strip experiment were taken apart in a glove box and the separator/electrolytes dried in the vacuum chamber of the glove box and stored for SEM analysis. The galvanostatic experiment was performed under different charging/discharging rate (0.315, 0.630, and 1.575 mA cm⁻², which corresponds to 1C, 2C and 5C, respectively).

Nafion/nanoporous alumina laminates were prepared by the solvent casting approach. Briefly, a predetermined amount of active polymer solution was dispersed on a clean piece of Kapton polyimide film, and then the nanoporous alumina was placed on the polymer solution. After evaporating the solvent, the Kapton film was carefully peeled of and thus an intact active polymer/alumina membrane was obtained. Then the composite membranes were lithated by soaking in 2M LiCl solution for overnight, and then 0.05M LiOH was used to titrate the pH to neutral. The lithated composite membranes were rinsed with DI water and transferred into large amount of PC with the presence of molecule sieves and lithium metal. PC was repeatedly refreshed to remove the residual water.

All references, including publications, patent applications, and patents cited herein are hereby incorporated by reference in their entireties to the same extent as if each reference was individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it was individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. A composite comprising:
a core membrane comprising a first nanoporous material; and
a pair of cladding material layers one laminated to each side of the core membrane, the pair of cladding material layers comprising a second nanoporous material different from the first nanoporous material and comprising a polymer material.

2. The composite of claim 1 wherein the first nanoporous material is selected from the group consisting of metal oxide materials, glass materials and carbon materials.

3. The composite of claim 1 wherein the first nanoporous material comprises a metal oxide material.

4. The composite of claim 3 wherein the metal oxide material comprises at least one metal selected from the group consisting of aluminum, silicon, titanium, vanadium, tin and zirconium metals.

5. The composite of claim 1 wherein the second nanoporous material comprises a thermoplastic polymer material.

6. The composite of claim 5 wherein the thermoplastic polymer material is selected from the group consisting of fluorinated thermoplastic polymer materials, fluorinated ionomer polymer materials and non-fluorinated thermoplastic polymer materials.

7. The composite of claim 1 wherein:
each of the first nanoporous material and the second nanoporous material has:
a pore area greater than about 50 area percent;
a pore size from about 2 to about 500 nanometers; and
the composite has a modulus greater than about 0.5 GPa.

8. A battery separator comprising:
a core membrane comprising a first nanoporous material;
a pair of cladding material layers one laminated to each side of the core membrane, the pair of cladding material layers comprising a second nanoporous material different from the first nanoporous material and comprising a polymer material; and
a battery electrolyte infused into the core membrane and the pair of cladding material layers.

9. The battery separator of claim 8 wherein:
each of the first nanoporous material and the second nanoporous material has:
a pore area greater than about 50 area percent;
a pore size from about 2 to about 500 nanometers;
the battery separator has:
a modulus greater than about 0.5 GPa; and
an ion conductivity greater than about 1 mS/cm.

10. The battery separator of claim 8 wherein:
first nanoporous material is selected from the group consisting of metal oxide materials, glass materials and carbon materials;
the second nanoporous material comprises a thermoplastic polymer material.

11. The battery separator of claim 8 wherein:
the first nanoporous material comprises a γ-Al₂O₃material; and
the second nanoporous material comprises a poly (vinylidene-fluoride-co-hexafluoropropene) material.

12. A battery comprising an anode separated from a cathode by a separator comprising:
a core membrane comprising a first nanoporous material;
a pair of cladding material layers one laminated to each side of the core membrane, the pair of cladding material layers comprising a second nanoporous material different from the first nanoporous material and comprising a polymer material; and
a battery electrolyte infused into the core membrane and the pair of cladding material layers.

13. The battery of claim 12 wherein:
each of the first nanoporous material and the second nanoporous material has:
a pore area greater than about 50 area percent;
a pore size from about 2 to about 500 nanometers; and
the battery separator has:
a modulus greater than about 0.5 GPa; and
an ion conductivity greater than about 1 mS/cm.

14. The battery of claim 12 wherein:
first nanoporous material is selected from the group consisting of metal oxide materials, glass materials and carbon materials;
the second nanoporous material comprises a thermoplastic polymer material.

15. The battery of claim 12 wherein:
the first nanoporous material comprises a γ-Al₂O₃ material;
the second nanoporous material comprises a poly (vinylidene-fluoride-co-hexafluoropropene) material; and
the battery electrolyte comprises a lithium bis(trifluoromethanesulfone) imide in propylene carbonate material.

16. The battery of claim 12 wherein at least one of the cathode and the anode uses a metal material selected from the group consisting of lithium, sodium, potassium, aluminum, zinc, copper and lead metal materials.

17. A method for fabricating a composite comprising:
anodically oxidizing a metal conductor material membrane to provide a nanoporous metal oxide material membrane; and
solution coating each side of the nanoporous metal oxide material membrane with a polymer material to provide a sandwich-type laminated nanoporous composite.

18. The method of claim 17 wherein the sandwich-type laminated nanoporous composite has a modulus greater than about 0.5 GPa.

19. The method of claim 17 further comprising infusing the sandwich-type laminated nanoporous composite with a battery electrolyte.

20. The method of claim 17 wherein:
the first nanoporous material comprises a γ-Al₂O₃ material; and
the second nanoporous material comprises a poly (vinylidene-fluoride-co-hexafluoropropene) material.
